(19) United States
(12) Patent Application Publication
(10) Pub. No.: US 2017/0249670 A1
(43) Pub. Date: Aug. 31, 2017

(54) TARGETED ADVERTISING AND FACIAL EXTRACTION AND ANALYSIS

(71) Applicants: Maher S. AWAD, Ottawa (CA); Robert LAGANIERE, Gatineau (CA)

(72) Inventors: Maher S. AWAD, Ottawa (CA); Robert LAGANIERE, Gatineau (CA)

(21) Appl. No.: 15/509,288

(22) PCT Filed: Sep. 8, 2015
(86) PCT No.: PCT/CA2015/050864

§ 371 Date: Mar. 7, 2017

Related U.S. Application Data
(60) Provisional application No. 62/047,232, filed on Sep. 8, 2014.

(51) Int. Cl. G06Q 30/02

(52) U.S. Cl. CPC G06Q 30/0269; G06Q 30/0275; G06K 9/00288

(57) ABSTRACT

Systems, methods, and devices relating to automatic facial detection and age and/or gender determination. An image source provides a sequence of images of an audience. Each image is analyzed to detect each face in the image. Specific features of each face are then extracted and, from these features, the gender and/or age of the face is determined by referring to previous determination results. Once the age and/or gender of the audience has been determined, a server can then select which advertisement spots can be presented to the audience. This may be done by having the server request access to a database of available advertising spots, submits specific parameters as the basis for the selection of the advertisement. Image source, image processing subsystems, advertisement displays and advertisements databases can be collocated or distributed over various network resources.

### TECHNICAL FIELD

The present invention relates to advertising and facial detection systems. More particularly, the present invention relates to methods and systems for automatically detecting people's faces from at least one image and determining to which age group and gender a specific human being's face belongs to. This detection and determination can be used for multiple uses including advertising.

### BACKGROUND

Advertising is most effective when an advertiser's specific message is presented to a specific targeted demographic. Improperly presented advertising can be completely useless when a target audience is not present. As an example, an advertisement spot promoting a line of girl's dolls is ineffective when presented to an audience composed mostly of middle aged men. Similarly, an advertising spot promoting a multi-bladed razor cartridge is ineffective when the audience consists of mostly adolescent girls. Advertisers' targeting of audience in Digital Out Of Home (DOOH) markets lags behind the online and mobile devices targeting due to the lack of ability to determine and integrate audience demographic into advertising systems in real time.

To maximize the impact of an advertising spot or campaign, it should therefore be presented to its target gender and demographic. This, unfortunately, can be quite difficult especially when dealing with crowds of people. The composition of the crowd or audience would need to be determined and an advertising spot geared towards the majority of the audience would need to be requested, selected and presented. Currently, this cannot be done in distributed advertising out of home networks.

### SUMMARY

The present invention provides systems, methods, and devices relating to automatic facial detection and age and/or gender determination. An image source provides a sequence of images of an audience. Each image is analyzed to detect each face in the image. Specific features of each face are then extracted and, from these features, the gender and/or age of the face is determined by referring to previous determination results. Once the age and/or gender of the audience has been determined, a server can then select which advertisement spots can be presented to the audience. This may be done by having the server access a database of available advertising spots. A suitable advertisement spot can then be selected for the audience.

In a first aspect, the present invention provides a system for determining which advertisements to provide to an audience, the system comprising:
at least one image source for providing at least one image of said audience;
a processing server for receiving said at least one image and for processing said at least one image, said processing server determining at least one of an age group and a gender of at least one member of said audience;
an advertisement server for selecting advertisements to be presented to said audience, said advertisement server selecting advertisements based on results from said processing server.

In a second aspect, the present invention provides a method for detecting and classifying faces in an image, the method comprising:
a) detecting a face in said image;
b) determining a score for said face, said score being related to whether a view of said face is suitable for analysis;
c) adjusting an alignment of said face to conform to a predetermined position;
d) determining a face descriptor for said face;
e) classifying a characteristic for said face based on said face descriptor determined in step d).

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a flowchart of a method according to another aspect of the invention; and

FIG. 3 is a flowchart of another method according to another aspect of the invention.

### DETAILED DESCRIPTION

The present invention relates to systems, methods, and devices for automatic facial detection and age and/or gender determination. An image source provides a sequence of images of an audience. Each image is analyzed to detect each face in the image. Specific features of each face is then extracted and, from these features, the gender and/or age of the face is determined by referring to previous determination results. Once the age and/or gender of the audience has been determined, a server can then select which advertisement spots can be presented to the audience. This may be done by having the server request access to a database of available advertising spots, submits specific parameters as the basis for the selection of the advertisement. Image source, image processing subsystems, advertisement displays and advertisements databases can be collocated or distributed over various network resources.

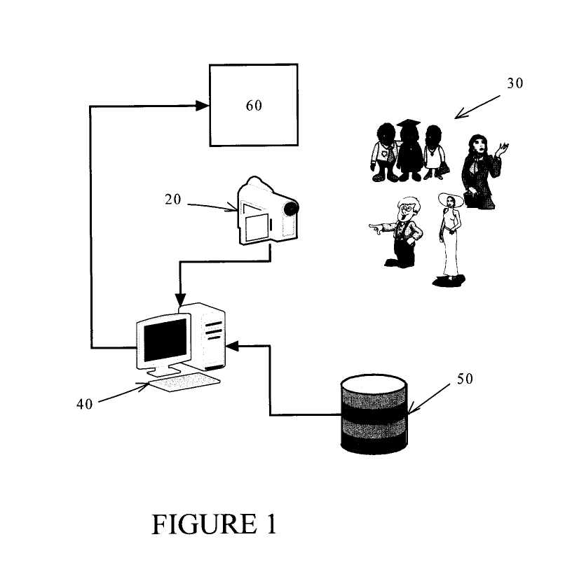

Referring to FIG. 1, a block diagram of a system according to one aspect of the invention is illustrated. The system 10 has an image source 20 which takes at least one image (or a series of images) of an audience 30. The image source 20 sends the images to a server 40. The server 40 extracts and classifies an image of at least one face from the images from the image source.

In one variant of the invention, depending on the results from the server 40 as to the composition of the audience, the server 40 selects a suitable advertisement to present to the audience. The advertisement can be accessed from a database of advertisements 50. The selected advertisement can then be presented to the audience by way of an advertisement space 60.

It should be noted that the image source 20 may be a video camera and the images sent to server 40 may be a sequence of images (i.e. video frames) extracted from a video feed from the video camera. The server 40 would, in this embodiment, use the video feed as a series or sequence of discrete still images. Each still image can then be analyzed to extract images of faces in the audience.

The image source 20 may also be a digital camera and/or a connected communicating digital camera that produces still images of the audience. These still images can then be processed by the server 40 to locate, isolate, and classify the faces in the audience images. A digital camera can be programmed to take images at specific intervals to produce a sequence of images for the server 40.

It should be noted that the images from the image source can be either group images of the audience featuring a subset of the audience or images of individuals from the audience. Preferably, the image source is static so that the focus of the image source is non-changing. This allows for the tracking of faces between sequential images from the image source. If a non-static image source is used, facial tracking between images may still be performed however more steps will need to be taken.

In one variant of the invention, the server 40 performs an analysis of the composition of the audience from the faces extracted and classified from the images from the image source. The genders and/or the age groups of the members of the audience are analyzed according to various criteria. Based on these criteria, the server 40 can select or receive advertisements from the advertisement database 50. Depending on the configuration of the system, the server 40 can use the analysis results, in conjunction with predetermined criteria, to select one or more suitable advertisement spots from the database. In another variant, the server 40 sends the analysis results (or data derived from the analysis results) to the database. The database can then use this data, in conjunction with predetermined criteria, to select one or more suitable advertisement spots for the advertisement space 60. Each advertisement spot is then sent to the server 40 for presentation to the audience. As an example, if the criteria includes presenting advertisements based on the largest demographic represented by the audience and the largest demographic in the audience consisted of adult females under the age of 60, then the server or the database may select a women's perfume advertisement. Conversely, if the criterion for the largest male age group represented and most of the males in the audience were between the ages of 20 and 60, then the advertisement could be that of an alcoholic beverage (e.g. beer).

In yet another variant, instead of predetermined criteria, the server 40 could select an advertisement based on which advertiser has the highest real-time bid for the advertising space. As an example, the server 40 may analyze the audience and determine which demographics are represented and how large or small is each contingent of each demographic. Thus, in one example, the audience may be 65% female and 35% male with 10% in their senior (i.e. over 60) years, 15% under the age of 20 (i.e. teenagers and younger), and the balance being of adult age (i.e. 75%). An advertiser for children's toys would not bid very high for the advertising space as only 15% of the audience would be in its target demographic. Similarly, an advertiser for adult incontinent pants would not bid very highly either as the audience only has 10% of its members in its target demographic. However, advertisers whose target demographic is those between the ages of 20 and 60 may bid quite high as a majority of the audience is within that age group. In fact, advertisers who are targeting women between the ages of 20 and 60 would probably bid the highest as just under half of the audience is composed of its target demographic.

The bidding for the target space can be conducted in real-time and can be for a specific time window for the advertising space. Thus, bidding can be for the next 3 minutes from the time the server has analyzed the audience. Once the time window is about to elapse, the server can provide updated data on the composition of the audience for the bidders. In the event the advertising space is in a shop window in a high traffic thoroughfare in a shopping mall, the audience would be constantly changing and each time window can provide advertisers with differing opportunities.

Regarding the isolation and extraction of the images of the various faces in the sequence of images from the video source, this can be accomplished by using the method as outlined below.

The method consists of, first, isolating and preparing a facial image from a still image. The prepared facial image is then analyzed to extract data to be used in classifying the face in the image. The extracted data is then used to classify the face in terms of its gender and/or its age group. In other variants of the method, each face detected in one still image can be tracked across a given sequence of still images. A single face detected and tracked across a sequence of still images can then be used to more accurately classify what gender and/or age group that face belongs to.

The method begins with obtaining still images from the image source. Depending on the configuration of the image source, this may take a number of forms. If the image source is a video camera, consecutive frames from the video feed can be used as sequential still images for analysis. If the image source is a digital camera which takes still images at predetermined intervals, these still images should not need any preprocessing before being analyzed by the server 40.

Once the images have been obtained, each image can then be processed separately by the server. Each image is processed to detect faces within the image. This is done by applying the Haar Cascade Face Detector for frontal faces (Viola-Jones method) to each image. This face detection method is discussed in more detail at the following webpage (the entirety of which is hereby incorporated by reference):

http://docs.opencv.org/doc/tutorials/objdetect/cascade_classifier/cascade_classifier.html

The result of this action, if it is successful, is a vector that holds the location of detected faces per frame. The faces could be of different sizes. In one implementation, the face detection is performed by calling the function detectMultiScale from the code listed in the webpage.

Once the face has been detected from an image, that facial image is “graded” or assessed to determine if the image is suitable for further analysis. A scoring function scores a “faceness” or whether a specific facial image can be considered to be a suitable or useful face. This function is applied to the facial image to measure the quality of the landmark configurations in the facial image. The resulting value determines if the detected face is in a frontal position. If a facial image has a score that is below a given threshold, then that facial image is not considered to be a “face” for analysis purposes. Preferably, the age and gender classification is applied only on well-posed faces. Further discussions regarding this step can be found in the following document, the entirety of which is hereby incorporated by reference:
Michal U\check{r}i\check{c}á\check{r}, Vojt\check{e}ch Franc, Václav Hlavá\check{c} (2012) Detector of facial landmarks learned by the structured output svm, 547-556. In VISAPP '12: Proceedings of the 7th International Conference on Computer Vision Theory and Applications.

To analyze each facial image, each useful facial image is, preferably, rotated and translated such that suitable markers can be determined and extracted prior to analyzing the face's gender and/or age. This is done by aligning the facial image to a predetermined coordinate system. The face alignment procedure aims to arrange each facial image such that the location of the center of both eyes and the face dimensions coincide. To accomplish this, the face objects (i.e. the facial image after the face has been extracted) are rotated and scaled until the left and right eyes are on the coordinates (26,25) and (76,25), respectively relative to a given coordinate system. In one implementation, the facial image is resized, rotated, and cropped until an image size of approximately 100×100 pixels is obtained with the eye locations at the predefined coordinates.

Once a face is in the correct position and is in the correct size, different types of visual features can be extracted.

The visual features of each facial image can be captured using a face descriptor. A face descriptor is made by concatenating a group of local descriptors. Local descriptors include texture features and a shape descriptor extracted from different areas of the facial image, and these may be of different sizes. For gender recognition 169 LBP (Local Binary Pattern) features can be used. Age recognition classification can use 110 and 60 feature bins for the uniform LBP and SIFT (Scale-invariant feature transform) features, respectively. Information about the location of the region from which descriptors should be extracted can be centralized in specific files.

Once each facial image has been analyzed for descriptors, it can then be classified relative to its gender and age group. For this classification task, the Support Vector Machine (SVM) technique (in conjunction with an RBF (Radial Basis Function) kernel) is used. The kernel utilized is the well-known RBF kernel. The parameters for the kernel are tuned using

K_{RBF}(x,y)=βexp{−γ∥x−y∥²}

The SVM can be trained using the logic in the following code:

| | |
|---|---|
| 1 | CvSVM MYSVM; |
| 2 | CvSVMParams params; |

3

| | |
|---|---|
| 4 | void OPENCVSVM::Svm_Train(Mat& trainingDataMat, Mat& |
| | labels) { |

5

| | | |
|---|---|---|
| 6 | params.svm_type | = CvSVM::C_SVC; |
| 7 | params.kernel_type | = CvSVM::RBF; |
| 8 | params.term_crit | = cvTermCriteria(CV_TERMCRIT_EPS, |

1000, 1e−10);
9

| | |
|---|---|
| 10 | CvMat* weight=cvCreateMat(1, num_class, DataType<float> |

::type);
11

| | |
|---|---|
| 12 | for(int i=0;i<num_class;i++) |

| | |
|---|---|
| 13 | *(((float*)weight−>data.f1)+i)=float(num_class−1); |

14

| | |
|---|---|
| 15 | params.class_weights = weight; |
| 16 | params.gamma = float(1) / ( float(desc_size) * gamma ); |

17

| | |
|---|---|
| 18 | Mat labelsMat(1,dataNum, CV_32FC1, labels); |
| 19 | MYSVM.train(trainingDataMat, labelsMat, Mat( ), Mat( ), |

params);
20

| | |
|---|---|
| 21 | ... |

22

| | |
|---|---|
| 23 | } |

More information regarding the SVM aspect of the invention as well as the RBF kernel can be found in the following documents, all of which are hereby incorporated by reference:
V. Vapnik, S. E. Golowich, and A. J. Smola, Support Vector Method for Function Approximation, Regression Estimation and Signal Processing. In Proceedings of NIPS. 1996, 281-287.
B. E. Boser, I. M. Guyon and V. N. Vapnik, “A Training Algorithm for Optimal Margin Classifiers,” in Fifth Annual Workshop on Computational Learning Theory, Pittsburgh, 1992.
Vert, Jean-Philippe, Koji Tsuda, and Bernhard Schölkopf (2004). “A primer on kernel methods.” Kernel Methods in Computational Biology. MIT Press, 2004.
D. S. Broomhead, D. Lowe, “Radial basis functions, multi-variable functional interpolation and adaptive networks”, Technical report, Royal Signal & Radar Establishment, 1988.

Once the SVM has been properly trained with a suitable library of faces, it can then be used to predict a facial image's gender and/or age group. The SVM can provide an indication as to which age group the face potentially belongs to out of a predetermined group of age groups. Similarly, the SVM can provide an indication as to whether the face is potentially male or female. These predictions can be made with higher accuracy when combined with age and/or gender predictions for multiple facial images of the same face. This is explained further below.

In the event the image source provides a sequence of still images, either from sequential still digital photographs or frames extracted from a video feed, results for the facial image extraction can be improved by tracking the faces across different still images.

To track facial images across sequential images (or frames if from a video feed), the Kanade-Lucas-Tomasi Tracker (KLT) can be used to follow faces once they have been detected. A discussion of the facial tracker method and software code can be found in the following webpage (the webpage is incorporated herein by reference):

http://docs.opencv.org/trunk/doc/py_tutorials/py_video/py_lucas_kanade/py_lucas_kanade.html

For tracking faces across a sequence of different still images, each still image is first analyzed to determine what faces are detected in the image. Then, each face detected will have tracking points extracted. The tracking points and the relative position of each face in the still image can then be used to track that face across different still images.

Tracking a specific face across different still images is performed by, from an initial still image (image 1), detecting a specific face and extracting tracking points for that face. These specific tracking points are then tracked on the next still image (image 2) in the sequence of images. In the next still image (image 2), the new tracking points are compared to the tracking points from the first image (image 1). The average displacement of the new tracking points from the old tracking points is calculated. This average displacement gives the probable location of the face in this next still image (image 2). Since the location of the face is known in the first image, applying this average displacement to this location gives the probable or potential location of the face in the next still image (image 2). Once this location has been calculated, the face detection process is applied to this next still image (image 2) to detect the location of detected faces in the still image. If the face detection process detects a face in a location that matches a potential location for a tracked face, then there is a potential match. The size of the detected face in image 2 and the size of the tracked face in image 1 is compared. If the sizes of these two faces match (or is within a predetermined tolerance level) and the location of the image 2 face matches the potential location of the face in image 1 after taking into account the displacement, then these two faces match. It should be noted that a match indicates that this detected face in image 2 is probably the face of the same individual from image 1.

However, in the event that a detected face in image 2 does not match a tracked face from image 1 (i.e. the locations and/or size is not a match with a tracked face), then this detected face is considered to be a new face. This new face is then tracked using new resources (i.e. a new entry for tracked faces). Tracking new faces involves storing the location of the new face to be tracked in a vector of “known” faces.

In the event that no detected face matches a tracked face at the probable new location in image 2, the face detector process is re-applied to the specific probable new location but with more relaxed parameters. If the face detector process still does not detect a face in the probable new location, even with relaxed parameters (i.e. a lower “faceness” score is acceptable), then the tracked face is considered to be unmatched for that image. If a tracked face is unmatched for more than a given number of sequential still images (e.g. 15 still images), then that tracked face is removed. This would mean that the person with that tracked face has left the scene.

It should be noted that, when a detected facial image in a still image has been found to match a tracked face (i.e. the tracking points on the detected facial image match the tracking points from the tracked face), new tracking points are created for that detected facial image. Thus, while tracking points for image 1 is used to track a face in image 2, once a match has been made for that face in image 2, new tracking points for the face are extracted from image 2. These tracking points are then used to track the same face in image 3. Each tracked face in a still image will thus have new tracking points to be used in tracking the same face in an immediately subsequent still frame.

As noted above, a tracked face is tracked across multiple still images by extracting specific tracking points for each face and tracking those points in the various images. If, when tracking a specific face, more than half of those tracking points are lost, then that tracked face is deleted. As an example, if in image 1 a specific face is detected and tracked, then the set of tracking points for that specific face is saved. In image 2 (the second still image in a sequence), if only half or less than half of those same tracking points are found, then that specific face is deleted. This would mean that that specific face has left the scene or the face is occluded.

When tracking a specific face, each instance of that specific face across the sequence of still images is analyzed for gender and/or age group inclusion. To determine which gender and/or age group that face belongs to, the assessment for a specific predetermined number of still images is used and whichever group or gender has the majority is the result. As an example, a specific face may be tracked across twenty still images. The most recent fifteen still images may be used to determine a more accurate assessment of the age and/or gender of the face. If, of the fifteen still images, the SVM-based gender analysis results in 10 predictions that the face is male and five predictions that the face is female, then the final assessment for that face is that it is male as the majority of the most recent predictions indicate a male face. Similarly, if, for the age group analysis, for the same group of still images, 9 indicate an adult age group, 3 indicate a senior age group, and 3 indicate a teen or younger age group, then the face is considered to be an adult face. Again, this is because a majority of the most recent predictions (e.g. the most recent 15 predictions) indicate an adult face. In one implementation, only 3 age groups are used (teen and younger, adult, and senior) and the predetermined number of recent predictions is limited to the most recent 15 sequential still images.

As noted above, the use of the most recent predictions across a specific number of still images should produce a more accurate result for age and/or gender predictions.

In one implementation, the demographic attributes collected by the system are stored for further analysis in a SQLite database. The fields stored in each record are: Current system time, a facial identifier, Gender class, and Age group. To make the operation more efficient, the records are stored in blocks. A block contains information collected during a certain period of time which is defined by the user.

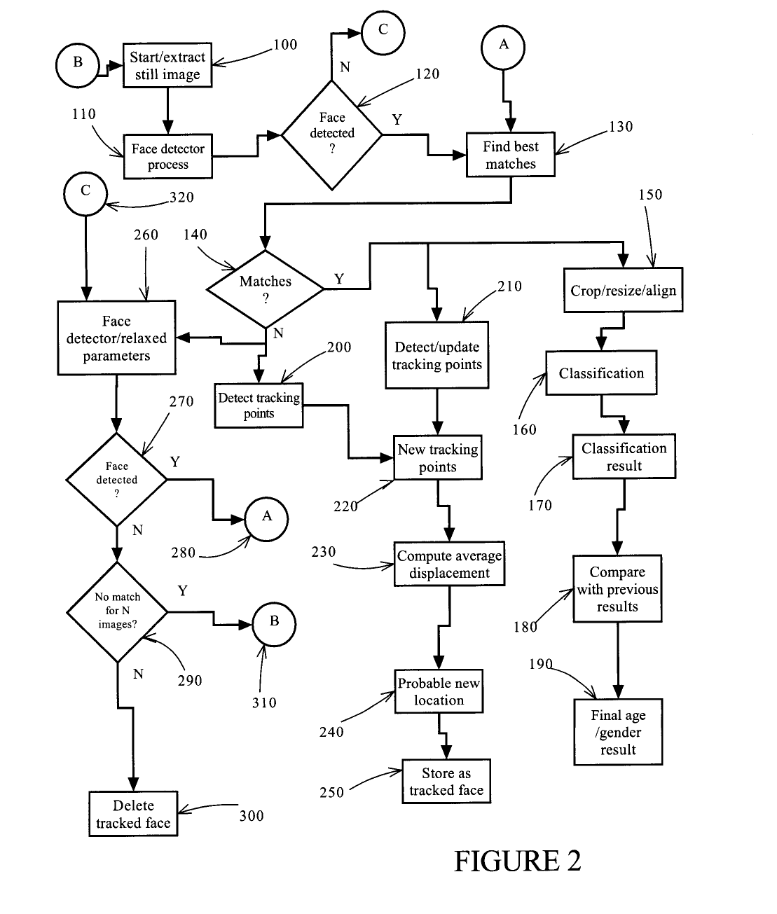

Referring to FIG. 2, a flowchart detailing the steps in a method according to one aspect of the invention is illustrated. The method begins with the reception and/or extraction of a still image (step 100). This step can involve the capture of a frame from a sequence of frames from a video feed or the reception of a still image from a sequence of images from a digital camera. The next step, step 110, is that of applying the face detector process on the still image. Decision 120 determines if a face has been detected in the still image. If a face has been detected, then the process for finding a best match for that detected face is applied (step 130). This step may involve determining if the detected face is in the correct location for a tracked face or if the tracking points on the detected face match the tracking points on a tracked face.

Continuing the process, if there are best matches for the detected face, then step 150 is that of adjusting and rotating the detected facial image so it can be analyzed. This step may involve cropping the facial image, aligning the image so the eyes are at specific coordinates, and resizing the image. After this step, the age and/or gender classification process is applied to the facial image (step 160). The result from the classification process is then received in step 170. This classification result is then compared with the previous classification results (i.e. the classification predictions) for the same face and a determination is made as to which age group and/or gender has the most predictions from the most recent results (step 180). A final determination (step 190) as to the gender and/or age group is then made based on the assessment from the previous step.

Returning to step 140, if there are no matches from the tracked faces, then step 200 is that of detecting tracking points on the detected face. Similarly, if there is a match found from the tracked faces, step 210 is that of detecting and updating tracking points on the matched and detected face.

From steps 200 and 210, the next step is that of collating the new tracking points (step 220). These new tracking points for the still image are then used to determine the potential location of the detected face in the next still image. This is done by computing the average displacement of the tracking points (step 230) and then determining the potential location of the now tracked face on the next still image (step 240). This tracked face is then stored as a tracked face (step 250).

Returning to step 140, if there are no matches for specific tracked faces, step 260 is that of applying a face detector process, with more relaxed parameters, to the potential location of a tracked face. Decision 270 then determines if a face has been detected. If a face has been detected, then the method returns to step 130 by way of connector 280. The detected face is, essentially, assessed against tracked faces.

In the event a face is not detected using the face detector process with more relaxed parameters, decision 290 determines, for each tracked face which has not been matched, how long a match has not been found. If a specific tracked face has not had a match for a predetermined number of sequential still images (e.g. N still images or frames), then this specific tracked face is deleted from the set of tracked faces. On the other hand, if the specific tracked face has not had a match for less than the predetermined number of still images, then the process returns to the start of the method by way of connector 310.

It should be noted that, for decision 120, if a face is not detected in the still image, then an assessment regarding the tracked faces is performed. This is done by following the process from step 260 on by way of connector 320.

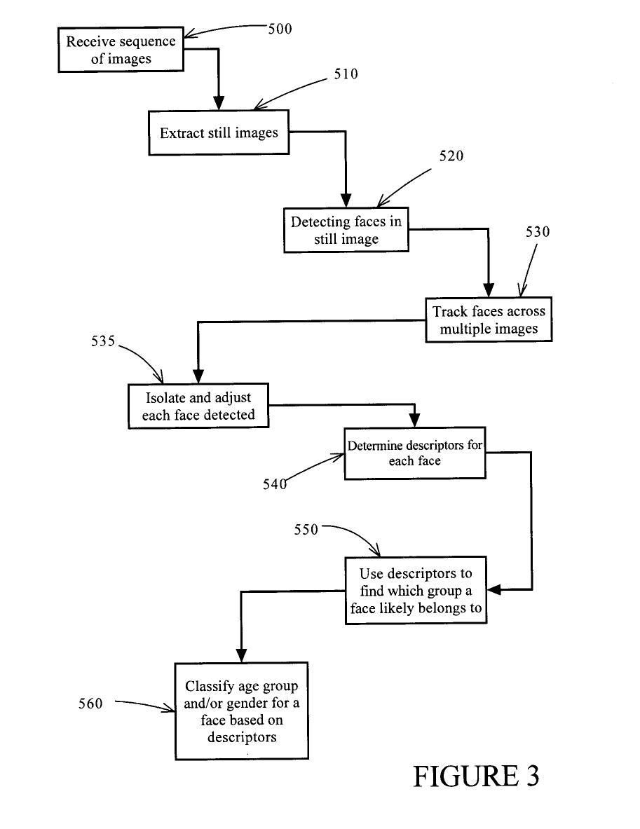

Referring to FIG. 3, a flow chart of a method according to another aspect of the invention is illustrated. The method starts at step 500 where a sequence of still images (or video frames) is received from an image source. Step 510 is that of extracting still images from the sequence received from the image source. Step 520 is that of detecting faces within each still image. This can be done per above using the Haar Cascade Face Detector or any other suitable method. The detected faces can then be tracked across multiple images or frames (step 530).

Once a facial image has been detected and tracked, it can then be isolated and adjusted (step 535). This is done by rotating and/or resizing the facial image isolated from the still image to ensure that that facial image is usable for analysis.

Each facial image is then analyzed to determine the facial descriptors for the face in the image (step 540). These descriptors are then used to determine to which group the face likely belongs to (step 550). An SVM, as explained above, may be used for this task.

When it has been determined, using an SVM, which group the face potentially belongs to, that face is classified as belonging to that group (step 560). This group can be one of two groups (for gender analysis) or the group can be one of multiple groups (for age group analysis).

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for determining which advertisements to provide to an audience, the system comprising:
at least one image source for providing at least one image of said audience;
a processing server for receiving said at least one image and for processing said at least one image, said processing server determining at least one of an age group and a gender of at least one member of said audience;
an advertisement server for selecting advertisements to be presented to said audience, said advertisement server selecting advertisements based on results from said processing server.

2. A system according to claim 1, wherein said advertisement server retrieves advertisements from an advertisement database.

3. A system according to claim 1, wherein said advertisement server selects advertisements based on input from a bidding server, said bidding server being for receiving bids from advertisers to present advertisements to said audience.

4. A system according to claim 1, wherein said advertisement server selects advertisements which are directed towards an age group of at least one member of said audience.

5. A system according to claim 1, wherein said advertisement server selects advertisements which are directed towards a gender of at least one member of said audience.

6. A system according to claim 1, wherein said processing server executes a method for automatically detecting faces in said at least one image and automatically classifies said faces into gender and age groups, the method comprising:
a) detecting a face in said at least one image;
b) determining a score for said face, said score being related to whether a view of said face is suitable for analysis;
c) adjusting an alignment of said face to conform to a predetermined position;
d) determining a face descriptor for said face;
e) classifying said face based on said face descriptor determined in step d).

7. A system according to claim 1, wherein said image source is a video camera and said at least one image is extracted from a video feed from said camera.

8. A system according to claim 1, wherein said image source is a digital still camera.

9. A system according to claim 1, wherein said at least one image source produces a sequence of images, said at least one image of said audience being extracted from said sequence of images.

10. A system according to claim 2, wherein said advertising server and said processing server are in a single computer.

11. A method for detecting and classifying faces in an image, the method comprising:
a) detecting a face in said image;
b) determining a score for said face, said score being related to whether a view of said face is suitable for analysis;
c) adjusting an alignment of said face to conform to a predetermined position;
d) determining a face descriptor for said face;
e) classifying a characteristic for said face based on said face descriptor determined in step d).

12. A method according to claim 10, wherein said characteristic is a gender of said face.

13. A method according to claim 11, wherein step e) further comprises determining which gender said face belongs to based on previous results of classifying other instances of said face.

14. A method according to claim 12, wherein step e) is executed using a support vector machine based method.

15. A method according to claim 10, wherein said characteristic is an age group of said face.

16. A method according to claim 14, wherein step e) further comprises determining which age group said face belongs to based on previous results of classifying other instances of said face.

17. A method according to claim 15, wherein step e) is executed using a support vector machine based method.

18. A method according to claim 10, wherein step c) comprises at least one of:
rotating an image of said face;
scaling an image of said face.

19. A method according to claim 10, wherein step d) comprises extracting local descriptors from different areas of said face and concatenating extracted local descriptors to result in said face descriptor.

20. A method according to claim 18, wherein said local descriptors comprise local binary pattern features.

21. A method according to claim 19, wherein said local descriptors comprise scale-invariant feature transform features.
